(19) United States
(12) Patent Application Publication
(10) Pub. No.: US 2011/0186744 A1
(43) Pub. Date: Aug. 4, 2011

(54) CHARGED PARTICLE BEAM APPARATUS AND METHOD

(75) Inventor: Hirohito ANZE, Shizuoka (JP)

(73) Assignee: NuFlare Technology, Inc., Numazu-shi (JP)

(21) Appl. No.: 12/984,071

(22) Filed: Jan. 4, 2011

(30) Foreign Application Priority Data
Jan. 29, 2010 (JP) 2010-018951

(51) Int. Cl. H01J 3/14

(52) U.S. Cl. 250/396 R; 250/492.1

(57) ABSTRACT

A first aperture 17 includes an opening 17a of a rectangular shape on a first quadrant and quarter-circular shape on a second quadrant, a third quadrant, and a fourth quadrant. A second aperture 18 includes an opening 18a of a rectangular shape on a third quadrant and quarter-circular shape on a first quadrant, a second quadrant, and a fourth quadrant. An electron beam 54 is shaped into a rectangular form by passing through the first quadrant of the first aperture 17 and the third quadrant of the second aperture 18. Additionally, the electron beam 54 is shaped into a spindle-like cross-sectional form by passing through the third quadrant of the first aperture 17 and the first quadrant of the second aperture 18.

### CROSS-REFERENCE TO RELATED APPLICATION

The entire disclosure of a Japanese Patent Application No. 2010-018951, filed on Jan. 29, 2010 including specification, claims, drawings and summary, on which the Convention priority of the present application is based, are incorporated herein by reference in its entirety.

### BACKGROUND OF THE INVENTION

1. Field of the Invention

The present invention relates to an apparatus and method for writing patterns with charged-particle beams. Particularly, the invention pertains to a variable beam-shaping type of charged-particle beam pattern-writing apparatus that uses apertures to shape a charged-particle beam, and to a charged-particle beam pattern-writing method that uses apertures to shape a charged-particle beam.

2. Background Art

The tendency in recent years towards higher mounting densities and larger capacities of large-scale integrated (LSI) circuits are further reducing the circuit line widths needed for semiconductor devices. Fabrication of semiconductor devices involves the use of photomasks or reticles (hereinafter, referred to collectively as masks) each having circuit patterns formed thereon. The circuit patterns on a mask are photolithographically transferred on to a wafer using a reduction projection exposure system, often called a stepper, whereby the circuit patterns are formed on the wafer. An electron beam pattern-writing apparatus capable of writing fine patterns is used to manufacture the masks used to transfer the fine circuit patterns onto the wafer. Developing a laser beam pattern-writing apparatus for writing patterns with laser beams has also been attempted. The electron beam pattern-writing apparatus is also used for writing circuit patterns directly onto the wafer.

In electron beam pattern-writing apparatuses, circuit patterns to be transferred onto a wafer are divided into basic graphics and then electron beams are shaped to the same size and form of the basic graphics via a plurality of shaping apertures. The shaped electron beams are next directed in sequence to the surface of a photoresist.

Methods of electron beam shaping include variable shaped beam (VSB). In the VSB scheme, electron beams can be shaped into rectangles and triangles by entering rectangular, triangular, and trapezoidal patterns as basic graphics and then controlling the amount of overlapping of the two apertures.

The variable beam-shaping type of electron beam pattern-writing apparatus includes two apertures that shape an electron beam emitted from an electron gun, into a first predetermined shape, and a shaping deflector provided between the apertures in order to shape optical overlaps thereof into a second predetermined shape. Between the apertures a projection lens is also arranged for creating a surface image on a second aperture with the first aperture as an object plane, and a reducing lens and objective lens for imaging on a sample the electron beam which has been shaped by the two apertures.

It is difficult in such an electron beam pattern-writing apparatus to write gentle, oblique lines having a given angle.

Oblique lines on masks are written by conducting a plurality of shots while slightly shifting a rectangular electron beam 101 as shown in FIG. 10a. The drawn pattern, when transferred onto a wafer, will ideally look as in FIG. 10b. Since the oblique line is approximated into a rectangular shape, however, the oblique section will have a staircase-like shape causing edge roughness. The edge roughness overstepping an allowable range may therefore be left on the shape obtained after the pattern transfer onto the wafer.

Increasing the number of shots will reduce the edge roughness. However, throughput will decrease. Meanwhile, apart from such an edge roughness level that causes no problem with a wafer transfer image of the mask pattern, a need may arise to determine the shape of the rectangular shots and the amount of overlapping between the shots while considering the throughput. This method, however, will also make it necessary for the shape of the rectangular shots and the amount of overlapping to be changed according to a particular inclination angle of the oblique line, thus resulting in complex processing of the pattern data to be written.

Writing oblique lines different in inclination angle and in line width will also require changing a shape of rectangular shots and the amount of overlapping therebetween. For example, suppose that when lines of an inclination angle θ and line width W are present as shown in FIG. 10b, lines of an inclination angle θ′ and line width W′ are to be additionally written as shown in FIG. 11b. In this example, as shown in FIG. 11a, an electron beam 103 will be shaped into a rectangle different from that shown in FIG. 10a. In addition, the amount of overlapping between the shots will be changed by changing the overlapping state 102 shown in FIG. 10a, to the overlapping state 104 shown in FIG. 11a. Such oblique lines as shown in FIG. 11b will thus ideally be written. However, if the shape of the rectangular shots and the amount of their overlapping are changed with each change of the inclination angle and line width, data preparation for pattern writing will be complex. This is because the amount of overlapping between the shots will need to be determined beforehand according to the particular angle and hence because conditioning will be necessary for simulation and experimentation.

In order to solve the above problems, Japanese Patent Laid-open No. Hei 5 (1993)-36595, discloses a method of alleviating the edge roughness of oblique sides of a non-rectangular pattern when dividing the non-rectangular pattern into a plurality of rectangular patterns. The alleviation involves preventing the edges of one of the rectangular patterns from protruding from the oblique sides of the non-rectangular pattern, and then imparting a light exposure level higher than that of the other rectangular shots proximate to the oblique sides. Alternatively, the alleviation involves protruding the edges of one of the rectangular patterns from the oblique sides of the non-rectangular pattern and then imparting a light exposure level lower than that of the other rectangular shots inclusive of the oblique sides. However, the edge roughness is likely to be difficult to improve by these adjustments of the exposure level.

Japanese Patent Laid-open No Hei 9(1997)-82630, in contrast, discloses an electron beam pattern-writing apparatus including two rectangular apertures and a third aperture provided below the two rectangular apertures, the third aperture being formed with a slit rotatable around an optical axis. This apparatus is claimed to be able to form any parallelogram beam. In addition to the third aperture, however, this apparatus tends to become complex since it requires a highly accurate motor and the like for rotating the third aperture.

The present invention has been made with the above taken into account. That is, an object of the invention is to provide a charged-particle beam pattern-writing apparatus that uses two apertures to shape beams, the apparatus enabling pattern data to be easily prepared and conditioned and throughput to be improved.

In addition, an object of the invention is to provide a charged-particle beam pattern-writing method that uses two apertures to shape beams, the method enabling pattern data to be easily prepared and conditioned and throughput to be improved.

### SUMMARY OF THE INVENTION

The present invention relates to a charged-particle beam pattern-writing apparatus and method for writing a desired pattern by irradiating the surface of a sample with a charged-particle beam formed using a plurality of apertures.

The first embodiment comprising; a charged-particle beam pattern-writing apparatus for writing a desired pattern by irradiating a surface of a sample with a charged-particle beam formed using a plurality of apertures, the apparatus comprising: a first aperture with an opening of a rectangular shape on a first quadrant and quarter-circular shape on a second quadrant, a third quadrant, and a fourth quadrant; and a second aperture with an opening of a rectangular shape on a third quadrant and quarter-circular shape on a first quadrant, a second quadrant, and a fourth quadrant.

In another embodiment of this invention; a charged-particle beam pattern-writing apparatus for writing a desired pattern by irradiating a surface of a sample with a charged-particle beam formed using a plurality of apertures, the apparatus comprising: a first aperture with an opening of a quarter-circular shape on a first quadrant and a fourth quadrant and rectangular shape on a second quadrant and a third quadrant; and a second aperture with an opening of a rectangular shape on a first quadrant and a fourth quadrant and quarter-circular shape on a second quadrant and a third quadrant.

In another embodiment of this invention; a charged-particle beam pattern-writing method for writing a desired pattern by irradiating a surface of a sample with a charged-particle beam formed using a plurality of apertures, the method comprising: using a first aperture with an opening of a rectangular shape on a first quadrant and quarter-circular shape on a second quadrant, a third quadrant, and a fourth quadrant; using a second aperture with an opening of a rectangular shape on a third quadrant and quarter-circular shape on a first quadrant, a second quadrant, and a fourth quadrant; and forming a charged-particle beam of a rectangular shape by passing the beam through the first quadrant of the first aperture and the third quadrant of the second aperture.

In another embodiment of this invention; a charged-particle beam pattern-writing method for writing a desired pattern by irradiating a surface of a sample with a charged-particle beam formed using a plurality of apertures, the method comprising: using a first aperture with an opening of a rectangular shape on a first quadrant and quarter-circular shape on a second quadrant, a third quadrant, and a fourth quadrant; using a second aperture with an opening of a rectangular shape on a third quadrant and quarter-circular shape on a first quadrant, a second quadrant, and a fourth quadrant; and forming a charged-particle beam of a spindle-like cross-sectional shape bypassing the beam through any combination of the third quadrant of the first aperture and the first quadrant of the second aperture, the second quadrant of the first aperture and the fourth quadrant of the second aperture, and the fourth quadrant of the first aperture and the second quadrant of the second aperture.

In another embodiment of this invention; a charged-particle beam pattern-writing method for writing a desired pattern by irradiating a surface of a sample with a charged-particle beam formed using a plurality of apertures, the method comprising: using a first aperture including an opening of a quarter-circular shape on a first quadrant and a fourth quadrant and rectangular shape on a second quadrant and a third quadrant; using a second aperture including an opening of a rectangular shape on a first quadrant and a fourth quadrant and quarter-circular shape on a second quadrant and a third quadrant; and forming a charged-particle beam of a rectangular shape bypassing the beam through the second quadrant and third quadrant of the first aperture and through the first quadrant and fourth quadrant of the second aperture.

In another embodiment of this invention; a charged-particle beam pattern-writing method for writing a desired pattern by irradiating a surface of a sample with a charged-particle beam formed using a plurality of apertures, the method comprising: using a first aperture including an opening of a quarter-circular shape on a first quadrant and a fourth quadrant and rectangular shape on a second quadrant and a third quadrant; using a second aperture including an opening of a rectangular shape on a first quadrant and a fourth quadrant and quarter-circular shape on a second quadrant and a third quadrant; and forming a charged-particle beam of a spindle-like cross-sectional shape by passing the beam through at least a portion of a region encompassing the first quadrant and fourth quadrant of the first aperture, and at least a portion of a region encompassing the second quadrant and third quadrant of the second aperture.

### BRIEF DESCRIPTION OF THE DRAWINGS

FIG. 1 is a block diagram of an electron beam pattern-writing apparatus according to an embodiment of the present invention.

FIG. 2 is an illustrative diagram of pattern writing with electron beams.

FIG. 3 is a schematic diagram showing a flow of data according to the present embodiment.

FIG. 4a is a plan view of an opening of the first aperture 17.

FIG. 4b is a plan view of an opening of the second aperture 18.

FIG. 5a shows an example of beam shaping in the electron beam pattern-writing apparatus.

FIG. 5b shows a manner of writing lines by repeating irradiation while slightly shifting the shot position.

FIG. 6a shows an example of beam shaping in the electron beam pattern-writing apparatus.

FIG. 6b shows a manner of writing oblique lines by repeating irradiation while slightly shifting the shot position.

FIG. 6c shows a manner of writing oblique lines by repeating irradiation while slightly shifting the shot position differing in inclination angle from FIG. 6b.

FIG. 7a is a plan view of an opening of the first aperture 17 shown in FIG. 1.

FIG. 7b is a plan view of an opening of the second aperture 18 shown in FIG. 1.

FIG. 8a shows an electron that has passed through the opening of both apertures.

FIG. 8b shows a manner of writing lines by repeating irradiation while slightly shifting the shot position.

FIG. 9a shows an electron beam that has passed through the opening of both apertures.

FIG. 9b shows a manner of writing oblique lines by repeating irradiation while slightly shifting the shot position.

FIG. 10a is an illustrative design of oblique lines written on masks.

FIG. 10b shows an example of a drawn pattern after transfer onto a wafer.

FIG. 11a shows another example of shaped electron beam.

FIG. 11b shows an example of a drawn pattern after transfer onto a wafer.

### DETAILED DESCRIPTION OF THE EMBODIMENTS

### First Embodiment

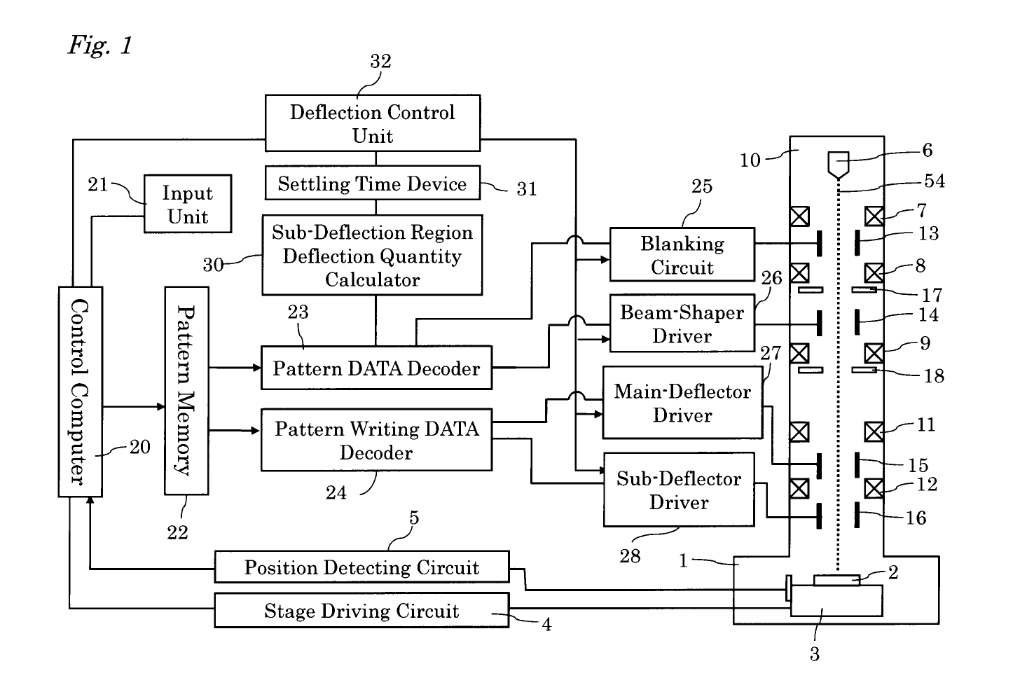

FIG. 1 is a block diagram of an electron beam pattern-writing apparatus according to an embodiment of the present invention.

Referring to FIG. 1, the sample chamber 1 of the electron beam pattern-writing apparatus includes a stage 3 with a mask substrate 2 set up thereupon. The stage 3 is driven by a stage driving circuit 4 to move the stage in plus and minus X-directions and plus and minus Y-directions. A position detection circuit 5, using a laser, critical-dimension measuring instrument or the like measures the moving position of the stage 3.

Electron beam optics 10 is disposed above the sample chamber 1. The electron beam optics 10 includes an electron gun 6, lenses 7, 8, 9, 11, 12, a blanking deflector 13, a shaping deflector 14, a main deflector 15 for beam scanning, a sub-deflector 16 for beam scanning, a first aperture 17 for beam shaping, a second aperture 18 for beam shaping and can include other elements.

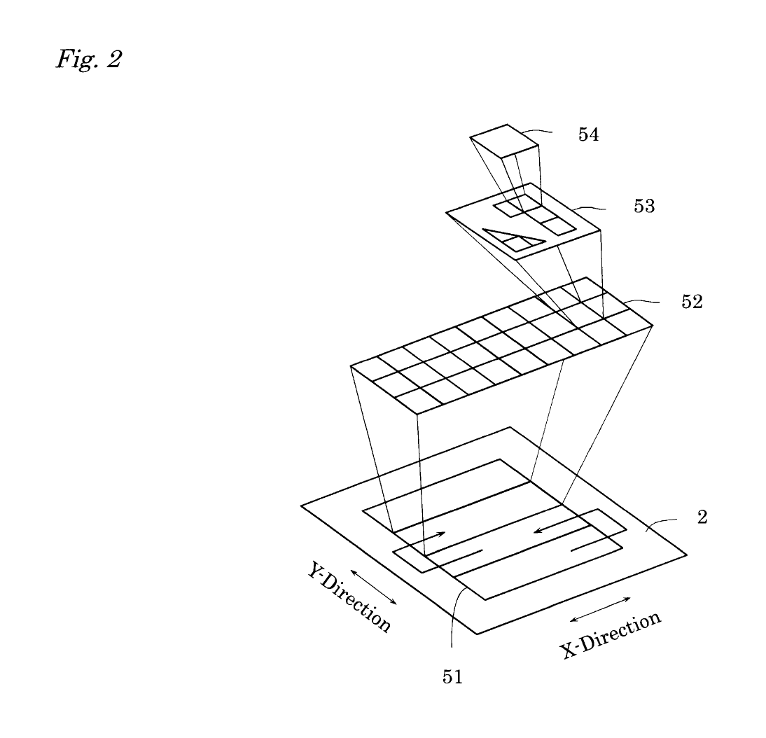

FIG. 2 is an illustrative diagram of pattern writing with electron beams. As shown in FIG. 2, patterns 51 that will be written on the mask substrate 2 are each divided into rectangular frame regions 52. Pattern writing with an electron beam 54 is repeated for each frame region 52 while the stage 3 continuously moves in one direction, for example in the plus or minus X-direction. The frame region 52 is further divided into sub-deflection regions 53, and the electron beam 54 writes only necessary internal portions of each sub-deflection region 53. The frame region 52 is a rectangular writing region determined by deflection width of the main deflector 15, and the sub-deflection region 53 is a unitary writing region determined by deflection width of the sub-deflector 16.

The electron beam 54 is positioned in the sub-deflection region 53 by the sub-deflector 16 as shown in FIG. 1. Position control of the sub-deflection region 53 is conducted by the main deflector 15 as shown in FIG. 1. That is, the sub-deflection region 53 is positioned by the main deflector 15, and the beam position in the sub-deflection region 53 is determined by the sub-deflector 16. In addition, the electron beam 54 has its shape and size determined by the shaping deflector 14 and the two apertures 17, 18. While the stage 3 is continuously moved in one direction, the inside of the sub-deflection region 53 is patterned, and upon completion of the pattern writing, the next sub-deflection region 53 is written. After all internal sub-deflection regions 53 of the frame region 52 have been written, the stage 3 is moved in steps in a direction (e.g., the plus or minus Y-direction) that is orthogonal to the continuous moving direction. After this, similar processing is repeated for sequential pattern writing of the frame region 52.

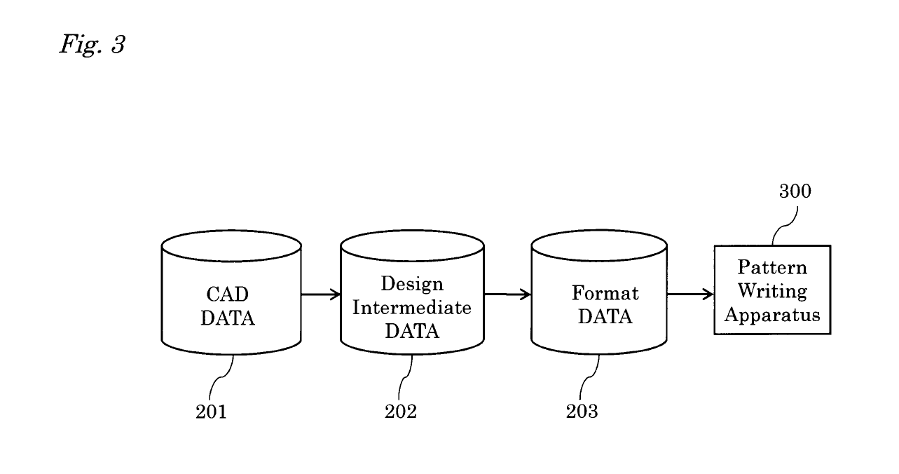

As shown in FIG. 3, CAD data 201 that a designer (user) has created is converted into design intermediate data 202 of a layered format such as OASIS. Pattern data that will be created for each layer and then formed on each mask is stored in a storage region for the design intermediate data 202. A pattern-writing apparatus 300 here is commonly not constructed to directly load OASIS data into the apparatus. In other words, different manufacturers of the apparatus 300 employ different data formats. For this reason, OASIS data is converted into characteristic format data 203 of the pattern-writing apparatus 300 on a layer-by-layer basis before being input to the apparatus.

The format data 203 is recorded in an input unit 21 of FIG. 1. The recorded data is read out by a control computer 20 and temporarily stored for each frame region 52 into a pattern memory 22. The pattern data that has been stored for each frame region 52 into the pattern memory 22, that is, frame information that includes pattern-writing positions, pattern-writing graphic data, and the like, is transmitted to a data-analyzing unit including a pattern data decoder 23 and a pattern-writing data decoder 24. The frame information is next transferred from these decoders to a sub-deflection region deflection quantity calculator 30, a blanking circuit 25, a beam-shaper driver 26, a main-deflector driver 27, and a sub-deflector driver 28.

The control computer 20 has a connected deflection control unit 32. The deflection control unit 32 connects to a settling time device 31. The settling time device 31 connects to the sub-deflection region deflection quantity calculator 30, which further connects to the pattern data decoder 23. The deflection control unit 32 also connects to the blanking circuit 25, the beam-shaper driver 26, the main-deflector driver 27, and the sub-deflector driver 28.

Information from the pattern data decoder 23 is sent to the blanking circuit 25 and the beam-shaper driver 26. More specifically, the pattern data decoder 23 creates blanking data based on pattern-writing data, and sends the blanking data to the blanking circuit 25. In addition, desired beam size data based on the pattern-writing data is created and sent to the sub-deflection region deflection quantity calculator 30 and the beam-shaper driver 26. A predetermined deflecting signal is then applied from the beam-shaper driver 26 to the shaping deflector 14 of the electron beam optics 10, thereby to control the shape and size of the electron beam 54.

The sub-deflection region deflection quantity calculator 30 calculates the quantity of electron beam deflection (moving distance) per shot in one sub-deflection region 53, from beam shape data that the pattern data decoder 23 has created. The calculated information is sent to the settling time device 31, which then sets an appropriate settling time according to the moving distance based on sub-deflection.

The settling time that the settling time device 31 has set is sent to the deflection control unit 32 and then transferred therefrom to any of the blanking circuit 25, the beam-shaper driver 26, the main-deflector driver 27, and the sub-deflector driver 28, as appropriate in timing of pattern writing.

The pattern-writing data decoder 24 creates positioning data for the sub-deflection region 53, based on the pattern-writing data, and transmits the positioning data to the main-deflector driver 27 and the sub-deflector driver 28. Next, the main-deflector driver 27 applies a predetermined deflecting signal to the main deflector 15 of the electron beam optics 10, thereby to scan the electron beam 54 for deflection to a predetermined main deflecting position. Additionally, the sub-deflector driver 28 applies a predetermined sub-deflecting signal to the sub-deflector 16, thereby conducting pattern writing in the sub-deflection region 53. More specifically, this pattern-writing operation is conducted by repeating irradiation with the electron beam 54 after the set settling time has passed.

Next, details of electron beam shaping in the present embodiment are described below.

For oblique line writing based on overlapped rectangular shots, data preparation for pattern writing tends to become complex because a change in inclination angle of the oblique line makes it necessary to change the amount of overlapping between shots and thus causes necessity for a vast deal of simulation for related conditioning. In such a case, even if the inclination angle changes, a change in the amount of overlapping between the shots can be avoided by rendering a shape of the shots circular. To change a size of circular shots, however, the lenses arranged in the electron beam optics require adjustment, which in turn makes it difficult to form circular shots of a given size.

The present inventor has therefore conducted studies to find possible ways to write oblique lines having different inclination angles without changing the amount of overlapping between shots, by forming two apertures each with an opening created as a combination of a circle and a rectangle. The following describes the apertures in the present embodiment, and a method of electron beam shaping with the apertures.

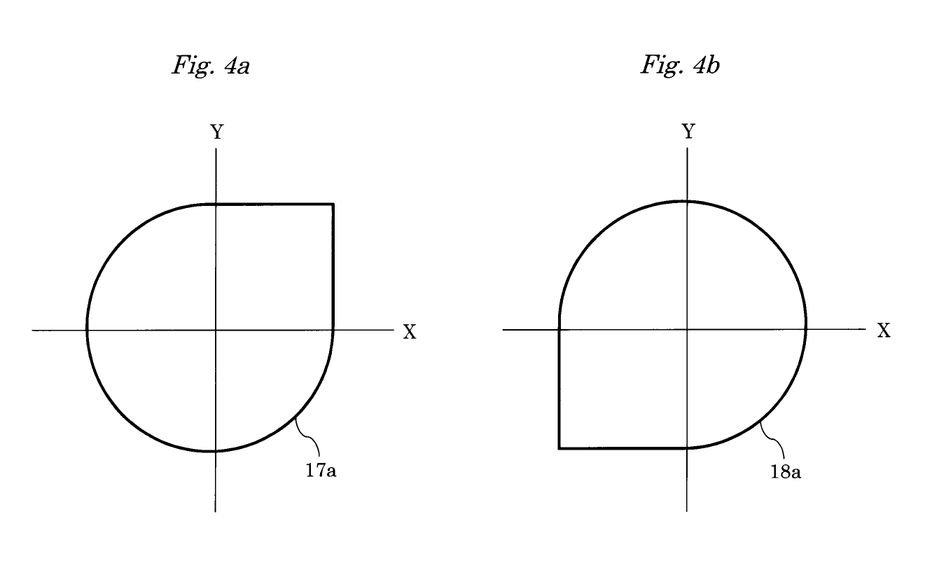

FIG. 4a is a plan view of an opening of the first aperture 17 shown in FIG. 1. As shown in FIG. 4a, the opening 17a of the first aperture 17 has a rectangular shape on a first quadrant (X>0, Y>0) of an X-Y coordinate plane and has a shape of a quarter circle on a second quadrant (X<0, Y>0), a third quadrant (X<0, Y<0), and a fourth quadrant (X>0, Y<0).

FIG. 4b is a plan view of an opening of the second aperture 18 shown in FIG. 1. As shown in FIG. 4b, the opening 18a of the second aperture 18 has a rectangular shape on a third quadrant (X<0, Y<0) of an X-Y coordinate plane and has a shape of a quarter circle on a first quadrant (X>0, Y>0), a second quadrant (X<0, Y>0), and a fourth quadrant (X>0, Y<0).

In the present embodiment, the opening 17a of the first aperture 17 and the opening 18a of the second aperture 18 have the same shape and size. In other words, rotating the opening 17a of FIG. 4a through 180 degrees about an origin makes the opening 17a completely overlap the opening 18a of FIG. 4b.

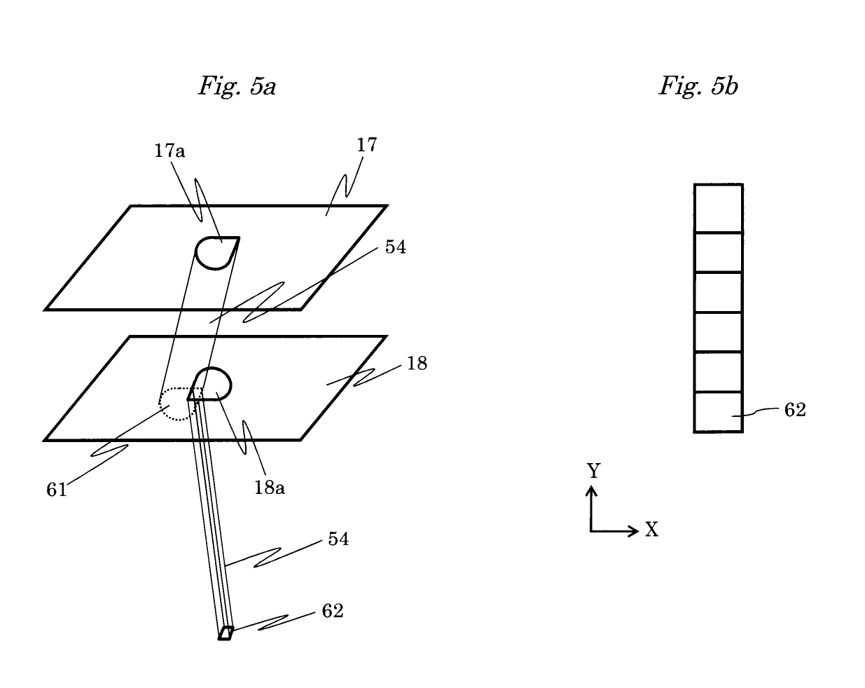

FIG. 5a shows an example of beam shaping in the electron beam pattern-writing apparatus using the first aperture 17 and the second aperture 18.

In FIG. 5a, the electron beam 54 that has passed through the opening 17a of the first aperture 17 is directed to the second aperture 18. The electron beam 54 is then deflected by the shaping deflector 14 in FIG. 1, next passing through the opening 18a of the second aperture 18.

Reference number 61 in FIG. 5a denotes an irradiation image of the electron beam 54 passed through the opening 17a and directed to the second aperture 18. When viewed on the X-Y coordinate plane, the irradiation image 61 has its first, second, third, and fourth quadrants corresponding to the first, second, third, and fourth quadrants, respectively, of the opening 17a of the first aperture 17.

As shown in FIG. 5a, the first quadrant of the irradiation image 61, that is, the first quadrant of the first aperture 17 overlaps the third quadrant of the second aperture 18. The opening 17a on the first quadrant of the first aperture 17 here has a rectangular shape. The opening 18a on the third quadrant of the second aperture 18 also has a rectangular shape. A region in which the first quadrant of the first aperture 17 and the third quadrant of the second aperture 18 overlap, therefore, takes a rectangular shape, whereby the electron beam 54 that has passed through the opening 18a of the second aperture 18 is shaped into a rectangular form and a rectangular shot 62 is formed.

In this way, since the two apertures are arranged so that the rectangular openings overlap each other, the electron beam passed therethrough is shaped into a rectangular form. FIG. 5b shows a manner of writing lines by repeating irradiation with the rectangular shot 62 while slightly shifting the shot position.

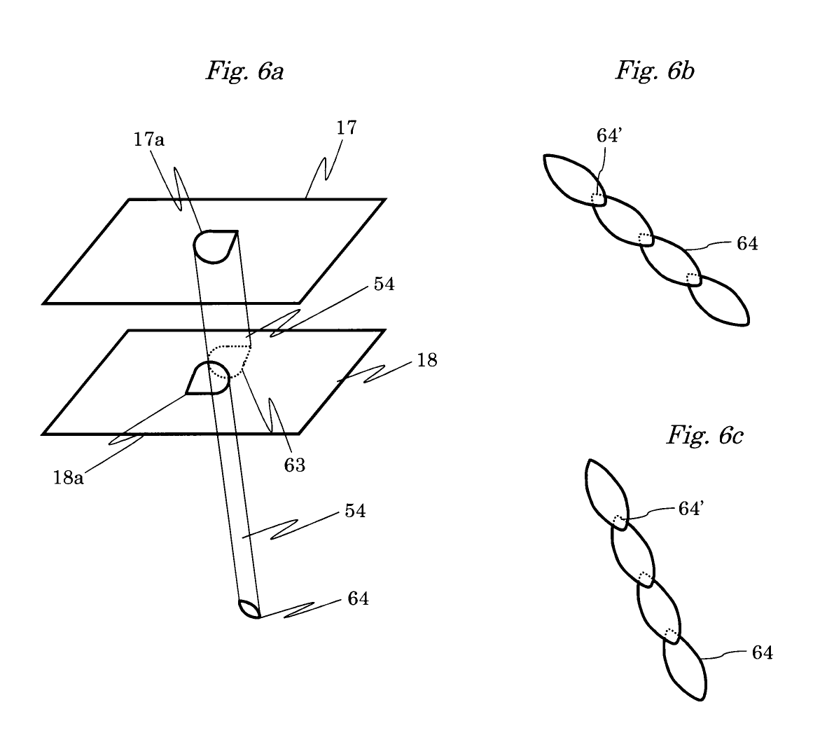

FIG. 6a shows another example of beam shaping in the electron beam pattern-writing apparatus using the first aperture 17 and the second aperture 18.

In FIG. 6a, the electron beam 54 that has passed through the opening 17a of the first aperture 17 is directed to the second aperture 18. The electron beam 54 is then deflected by the shaping deflector 14 in FIG. 1, next passing through the opening 18a of the second aperture 18.

Reference number 63 in FIG. 6a denotes an irradiation image of the electron beam 54 passed through the opening 17a and directed to the second aperture 18. When viewed on the X-Y coordinate plane, the irradiation image 63 has its first, second, third, and fourth quadrants corresponding to the first, second, third, and fourth quadrants, respectively, of the opening 17a of the first aperture 17.

As shown in FIG. 6a, the third quadrant of the irradiation image 63, that is, the third quadrant of the first aperture 17 overlaps the first quadrant of the second aperture 18. The opening 17a on the third quadrant of the first aperture 17 here has a shape of a quarter circle. The opening 18a on the first quadrant of the second aperture 18 also has the shape of a quarter circle. A region in which the third quadrant of the first aperture 17 and the first quadrant of the second aperture 18 overlap, therefore, takes a spindle-like cross-sectional shape surrounded by two arcs, as shown. Thus, the electron beam 54 that has passed through the opening 18a of the second aperture 18 is shaped into the spindle-like cross-sectional form and a spindle-like cross-sectional shot 64 is formed.

FIG. 6b shows a manner of writing oblique lines by repeating irradiation with the spindle-like cross-sectional shot 64 while slightly shifting the shot position. FIG. 6c also shows a manner of writing oblique lines. Between FIGS. 6b and 6c, the lines differ in inclination angle, but overlaps 64′ of adjoining shots 64 are of the same area.

As discussed above, in the conventional technique that uses rectangular shots, writing an oblique line having a different inclination angle has required changing the amount of overlapping between shots and resulted in complex data preparation. In the present embodiment, however, since a line having any inclination angle is written without a change in the amount of overlapping between shots, data preparation is simplified in comparison with that of the conventional technique. To change line width, a need arises to change the amount of overlapping between the irradiation image 63 and the opening 18a of the second aperture 18. However, since the difference in the amount of overlapping between the shots, due to the difference in inclination angle does not need to be considered, data preparation is significantly reduced in comparison with that of the conventional technique.

In FIG. 6b, the overlap 64′ is generated between the shots so as to render the line continuous. At the overlap 64′, however, a desired size is liable to be unobtainable if an exposure level of the beam is doubled. Accordingly, even if the line becomes discontinuous, this causes no problem with a wafer transfer image of the mask pattern, and shots can instead be conducted without generating the overlap 64′. Even in this case, there is no need to change an intershot clearance according to the particular inclination angle.

Additionally, aspects of the two apertures in the present embodiment are not limited to the examples shown in FIGS. 4a and 4b. That is, these openings have the same shape and size. One opening is arranged to completely overlap the other opening by the following operations: rotating the opening through 180 degrees about the origin; inverting the opening vertically about the X-axis; and inverting the opening horizontally about the Y-axis makes the opening.

For example, while it has been described that FIGS. 4a and 4b show the first aperture and the second aperture, respectively, these may be the other way around. In other words, the opening of the first aperture 17 can have a rectangular shape on the third quadrant (X<0, Y<0) of the X-Y coordinate plane and have the shape of a quarter circle on the first quadrant (X>0, Y>0), the second quadrant (X<0, Y>0), and the fourth quadrant (X>0, Y<0). In this case, the opening of the second aperture 18 will have a rectangular shape on the first quadrant (X>0, Y>0) of the X-Y coordinate plane and have the shape of a quarter circle on the second quadrant (X<0, Y>0), the third quadrant (X<0, Y<0), and the fourth quadrant (X>0, Y<0).

Alternatively, the opening of the first aperture 17 can have a rectangular shape on the second quadrant (X<0, Y>0) of the X-Y coordinate plane and have the shape of a quarter circle on the first quadrant (X>0, Y>0), the third quadrant (X<0, Y<0), and the fourth quadrant (X>0, Y<0). In this case, the opening of the second aperture 18 can have a rectangular shape on the fourth quadrant (X>0, Y<0) of the X-Y coordinate plane and have the shape of a quarter circle on the first quadrant (X>0, Y>0), the second quadrant (X<0, Y>0), and the third quadrant (X<0, Y<0).

Furthermore, in the present embodiment, while the third quadrant of the first aperture 17 and the first quadrant of the second aperture 18 have been overlapped to form a spindle-like cross-sectional shot, the second quadrant of the first aperture 17 and the fourth quadrant of the second aperture may be overlapped or the fourth quadrant of the first aperture and the second quadrant of the second aperture may be overlapped. A spindle-like cross-sectional shot can likewise be formed in the latter two cases.

### Second Embodiment

The second embodiment uses apertures whose openings have a shape different from that of the openings of the apertures described in the first embodiment. The electron beam pattern-writing apparatus of the present embodiment can have substantially the same configuration as the apparatus described in FIG. 1.

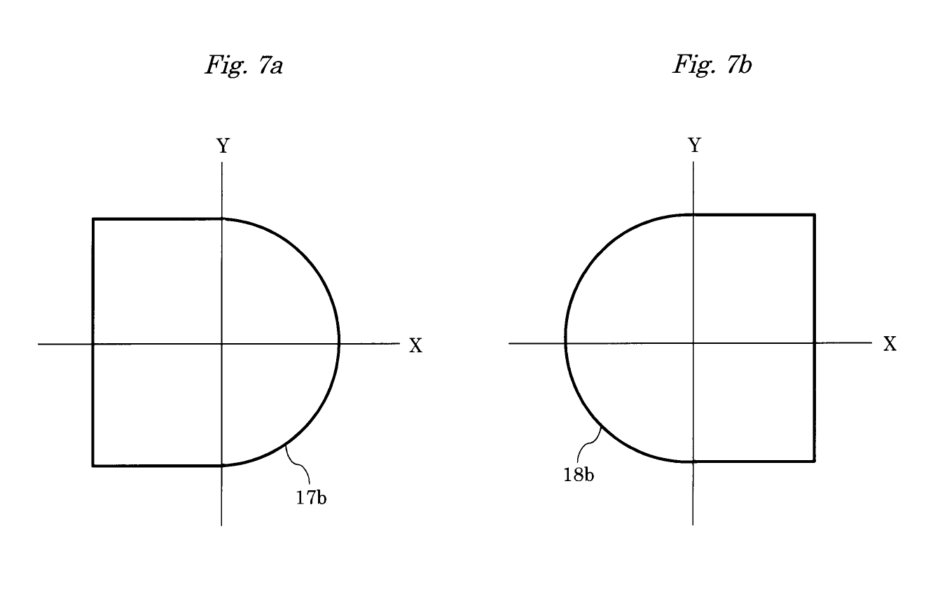

FIG. 7a is a plan view of an opening of the first aperture 17 shown in FIG. 1. As shown in FIG. 7a, the opening 17b of the first aperture 17 has a shape of a quarter circle on a first quadrant (X>0, Y>0) and fourth quadrant (X>0, Y<0) of an X-Y coordinate plane, and has a rectangular shape on a second quadrant (X<0, Y>0) and a third quadrant (X<0, Y<0).

FIG. 7b is a plan view of an opening of the second aperture 18 shown in FIG. 1. As shown in FIG. 7b, the opening 18b of the second aperture 18 has a rectangular shape on a first quadrant (X>0, Y>0) and fourth quadrant (X>0, Y<0) of an X-Y coordinate plane, and has a shape of a quarter circle on a second quadrant (X<0, Y>0) and a third quadrant (X<0, Y<0).

In the present embodiment, the opening 17b of the first aperture 17 and the opening 18b of the second aperture 18 have the same shape and size. In other words, rotating the opening 17b of FIG. 7a through 180 degrees about an origin, inverting the opening vertically about the X-axis, or inverting the opening horizontally about the Y-axis makes the opening completely overlap the opening 18b of FIG. 7b.

Substantially the same electron beams as those described in FIGS. 5a, 5b, 6a, 6b, 6c can be shaped by using the apertures of FIGS. 7a and 7b. These apertures in FIGS. 7a and 7b, however, enable formation of shots longer in the Y-axis than that of the apertures described in the first embodiment.

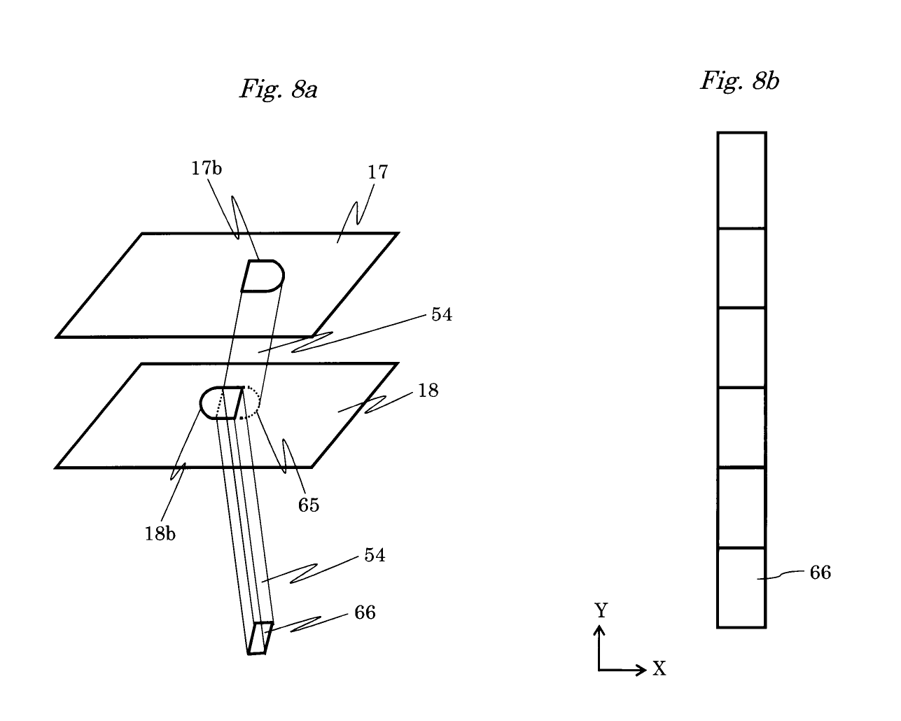

Linear pattern writing according to the present embodiment is described below using FIGS. 8a and 8b.

In FIG. 8a, the electron beam 54 that has passed through the opening 17b of the first aperture 17 is directed to the second aperture 18. The electron beam 54 is then deflected by the shaping deflector 14 of FIG. 1, next passing through the opening 18b of the second aperture 18.

Reference number 65 in FIG. 8a denotes an irradiation image of the electron beam 54 passed through the opening 17b and directed to the second aperture 18. When viewed on the X-Y coordinate plane, the irradiation image 65 has its first, second, third, and fourth quadrants corresponding to the first, second, third, and fourth quadrants, respectively, of the opening 17b of the first aperture 17.

As shown in FIG. 8a, the second quadrant and third quadrant of the irradiation image 65, that is, the second quadrant and third quadrant of the first aperture 17 overlap the first quadrant and fourth quadrant of the second aperture 18. Of the opening 17b, a region that encompasses the second quadrant and third quadrant of the opening is of a rectangular shape on the whole. Of the opening 18b, a region that encompasses the first quadrant and fourth quadrant of the opening is also of a rectangular shape on the whole. Therefore, the region in which the second quadrant and third quadrant of the first aperture 17 overlap the first quadrant and fourth quadrant of the second aperture 18 takes a rectangular shape. Thus, the electron beam that has passed through the opening 18b of the second aperture 18 is shaped into a rectangular form and a rectangular shot 66 is formed.

The electron beam 54 needs only to pass through at least a portion of the region encompassing the second quadrant and third quadrant of the first aperture 17, and at least a portion of the region encompassing the first quadrant and fourth quadrant of the second aperture 18. Thus, a charged-particle beam of a rectangular shape is formed.

In this way, since the two apertures are arranged so that the rectangular openings overlap each other, the electron beam passed therethrough is shaped into a rectangular form. FIG. 8b shows a manner of writing lines by repeating irradiation with the rectangular shot 66 while slightly shifting the shot position. If the rectangular sections of the opening 17b, on the second quadrant and third quadrant thereof, and the rectangular sections of the opening 18b, on the first quadrant and fourth quadrant thereof, have the same shape and size as those of the rectangular sections of the openings 17a, 18a of the apertures used in the first embodiment, Y-axial length of one shot in FIG. 8b is twice that of FIG. 5b. The number of shots can therefore be made smaller than that in the first embodiment.

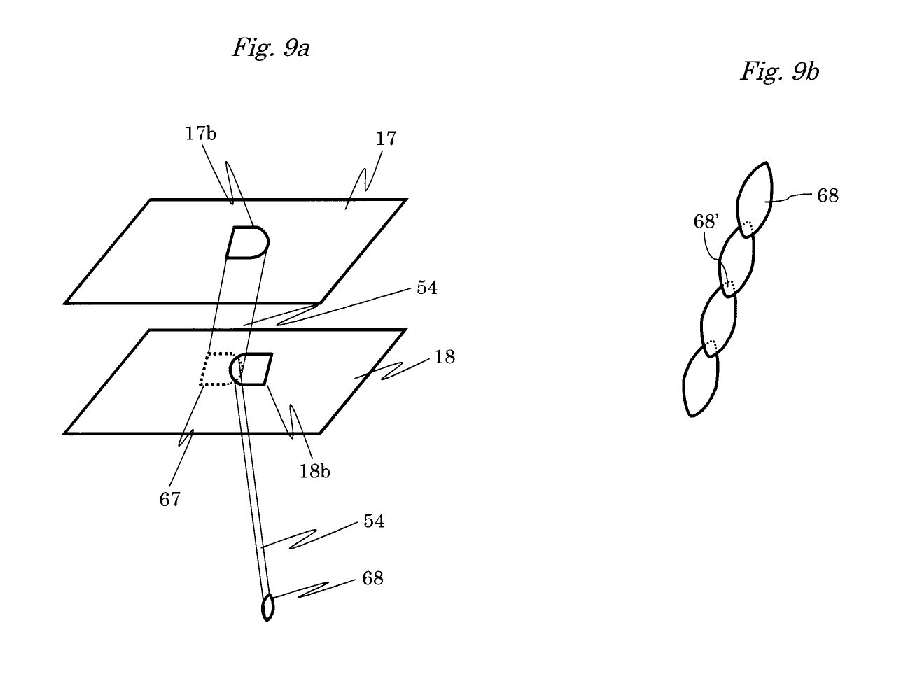

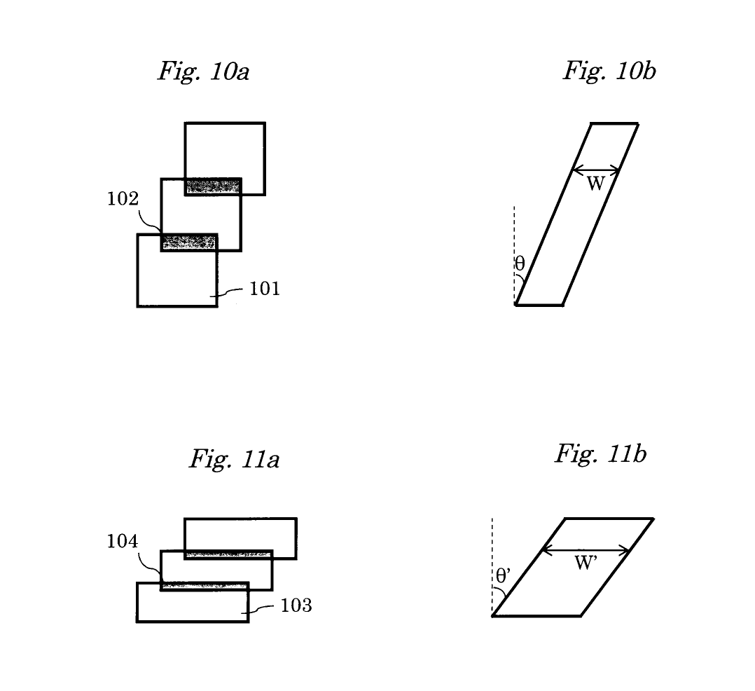

Writing oblique lines according to the present embodiment is described below using FIGS. 9a and 9b.

In FIG. 9a, the electron beam 54 that has passed through the opening 17b of the first aperture 17 is directed to the second aperture 18. The electron beam 54 is then deflected by the shaping deflector 14 of FIG. 1, next passing through the opening 18b of the second aperture 18.

Reference number 67 in FIG. 9a denotes an irradiation image of the electron beam 54 passed through the opening 17b and directed to the second aperture 18. When viewed on the X-Y coordinate plane, the irradiation image 67 has its first, second, third, and fourth quadrants corresponding to the first, second, third, and fourth quadrants, respectively, of the opening 17b of the first aperture 17.

As shown in FIG. 9a, the first quadrant and fourth quadrant of the irradiation image 67, that is, the first quadrant and fourth quadrant of the first aperture 17 overlap the second quadrant and third quadrant of the second aperture 18. Of the opening 17b of the first aperture 17, a region that encompasses the first quadrant and fourth quadrant of the opening is of a quarter-circular shape. Of the opening 18b of the second aperture 18, a region that encompasses the second quadrant and the third quadrant of the opening is also of a quarter-circular shape. Therefore, the region in which the first quadrant and fourth quadrant of the first aperture 17 overlap the second quadrant and third quadrant of the second aperture 18 creates a spindle-like cross-sectional shape. Thus, the electron beam 54 that has passed through the opening 18b of the second aperture 18 is shaped into the spindle-like cross-sectional form and a spindle-like cross-sectional shot 68 is formed.

The electron beam 54 needs only to pass through a region in which at least a portion of the region encompassing the first quadrant and fourth quadrant of the first aperture 17 overlaps at least a portion of the region encompassing the second quadrant and third quadrant of the second aperture 18. Thus, an electron beam of a spindle-like cross-sectional shape is formed.

FIG. 9b shows a manner of writing oblique lines by repeating irradiation with the shot 66 while slightly shifting the shot position. Similarly to pattern writing described in FIG. 6b, according to the present embodiment, oblique lines having any inclination angle are written without a change in area of an overlap 68′ between shots.

In FIG. 9b, the overlap 68′ is generated between the shots so as to render the line continuous. At the overlap 68′, however, a desired size is liable to be unobtainable if an exposure level of the beam is doubled. Accordingly, even if the line becomes discontinuous, this causes no problem with a wafer transfer image of the mask pattern, and shots can instead be conducted without generating the overlap 68′. Even in this case, there is no need to change an intershot clearance according to the particular inclination angle.

Additionally, aspects of the two apertures in the present embodiment are not limited to the examples shown in FIGS. 7a and 7b. That is, these openings have the same shape and size. One opening of FIG. 7 is arranged to completely overlap the other opening by the following operations: rotating the opening through 180 degrees about the origin; and inverting the opening horizontally about the Y-axis. In other words, a complementary relationship in terms of shape exists between the openings of the two apertures, and combining these shapes forms a complete circle or rectangle. For example, combining the first and fourth quadrants of FIG. 7a and the second and third quadrants of FIG. 7b creates a completely circular shape. Combining the second and third quadrants of FIG. 7a and the first and fourth quadrants of FIG. 7b creates a completely rectangular shape.

For example, while it has been described that FIGS. 7a and 7b show the first aperture and the second aperture, respectively, these may be the other way around. In other words, the opening of the first aperture 17 can have a rectangular shape on the first quadrant (X>0, Y>0) and fourth quadrant (X>0, Y<0) of the X-Y coordinate plane and have the shape of a quarter circle on the second quadrant (X<0, Y>0) and the third quadrant (X<0, Y<0). In this case, the opening 18b of the second aperture 18 can have the shape of a quarter circle on the first quadrant (X>0, Y>0) and fourth quadrant (X>0, Y<0) of the X-Y coordinate plane and have a rectangular shape on the second quadrant (X<0, Y>0) and the third quadrant (X<0, Y<0).

The present invention is not limited to the above embodiments and may be modified in various forms without departing from the scope of the invention. For example, while the above embodiments have used electron beams, the invention is not limited to such beam usage and can also be applied to the case of using other charged-particle beams such as ion beams.

In addition, although examples of writing lines and oblique lines using the electron beam pattern-writing apparatus of the invention have been described in the above embodiments, the invention can be applied to the case of writing curves.

Magnetic disk media, for example, generally employ a concentric track arrangement, in which case, servo patterns and other information patterns are formed along the concentric tracks. The charged-particle beam pattern-writing apparatus of the present invention is suitable for writing servo patterns and other predetermined high-density patterns on to, for example, original plates of supports for the magnetic transfer masters used for manufacturing magnetic disk media.

Description of factors and sections not directly required for the description of the present invention, such as a system configuration and a control method, has been omitted in the above embodiments. It goes without saying, however, that the system configuration and control method required can be selected and used as appropriate. All pattern inspection apparatuses or methods that include the elements of the invention and upon which a person skilled in the art can conduct necessary design changes are embraced in the scope of the invention.

The features and advantages of the present invention may be summarized as follows.

The present invention provides a charged-particle beam pattern-writing apparatus and method that uses two apertures to shape beams, the apparatus and method enabling pattern data to be easily prepared and conditioned and throughput to be improved.

Obviously many modifications and variations of the present invention are possible in the light of the above teachings. It is therefore to be understood that within the scope of the appended claims the invention may be practiced otherwise than as specifically described.

1. A charged-particle beam pattern-writing apparatus for writing a desired pattern by irradiating a surface of a sample with a charged-particle beam formed using a plurality of apertures, the apparatus comprising:
a first aperture with an opening of a rectangular shape on a first quadrant and quarter-circular shape on a second quadrant, a third quadrant, and a fourth quadrant; and
a second aperture with an opening of a rectangular shape on a third quadrant and quarter-circular shape on a first quadrant, a second quadrant, and a fourth quadrant.

2. The apparatus of claim 1, wherein a charged-particle beam of a rectangular shape is formed by passing the beam through the first quadrant of the first aperture and the third quadrant of the second aperture.

3. The apparatus of claim 1, wherein a charged-particle beam of a spindle-like cross-sectional shape is formed by passing the beam through any combination of the third quadrant of the first aperture and the first quadrant of the second aperture, the second quadrant of the first aperture and the fourth quadrant of the second aperture, and the fourth quadrant of the first aperture and the second quadrant of the second aperture.

4. A charged-particle beam pattern-writing apparatus for writing a desired pattern by irradiating a surface of a sample with a charged-particle beam formed using a plurality of apertures, the apparatus comprising:
a first aperture with an opening of a quarter-circular shape on a first quadrant and a fourth quadrant and rectangular shape on a second quadrant and a third quadrant; and
a second aperture with an opening of a rectangular shape on a first quadrant and a fourth quadrant and quarter-circular shape on a second quadrant and a third quadrant.

5. The apparatus of claim 4, wherein a charged-particle beam of a rectangular shape is formed by passing the beam through at least a portion of a region encompassing the second quadrant and third quadrant of the first aperture, and at least a portion of a region encompassing the first quadrant and fourth quadrant of the second aperture.

6. The apparatus of claim 4, wherein a charged-particle beam of a spindle-like cross-sectional shape is formed by passing the beam through at least a portion of a region encompassing the first quadrant and fourth quadrant of the first aperture, and at least a portion of a region encompassing the second quadrant and third quadrant of the second aperture.

7. A charged-particle beam pattern-writing method for writing a desired pattern by irradiating a surface of a sample with a charged-particle beam formed using a plurality of apertures, the method comprising:
using a first aperture with an opening of a rectangular shape on a first quadrant and quarter-circular shape on a second quadrant, a third quadrant, and a fourth quadrant;
using a second aperture with an opening of a rectangular shape on a third quadrant and quarter-circular shape on a first quadrant, a second quadrant, and a fourth quadrant; and
forming a charged-particle beam of a rectangular shape by passing the beam through the first quadrant of the first aperture and the third quadrant of the second aperture.

8. A charged-particle beam pattern-writing method for writing a desired pattern by irradiating a surface of a sample with a charged-particle beam formed using a plurality of apertures, the method comprising:
using a first aperture with an opening of a rectangular shape on a first quadrant and quarter-circular shape on a second quadrant, a third quadrant, and a fourth quadrant;
using a second aperture with an opening of a rectangular shape on a third quadrant and quarter-circular shape on a first quadrant, a second quadrant, and a fourth quadrant; and
forming a charged-particle beam of a spindle-like cross-sectional shape by the beam through any combination of the third quadrant of the first aperture and the first quadrant of the second aperture, the second quadrant of the first aperture and the fourth quadrant of the second aperture, and the fourth quadrant of the first aperture and the second quadrant of the second aperture.

9. A charged-particle beam pattern-writing method for writing a desired pattern by irradiating a surface of a sample with a charged-particle beam formed using a plurality of apertures, the method comprising:
using a first aperture including an opening of a quarter-circular shape on a first quadrant and a fourth quadrant and rectangular shape on a second quadrant and a third quadrant;
using a second aperture including an opening of a rectangular shape on a first quadrant and a fourth quadrant and quarter-circular shape on a second quadrant and a third quadrant; and
forming a charged-particle beam of a rectangular shape by passing the beam through the second quadrant and third quadrant of the first aperture and through the first quadrant and fourth quadrant of the second aperture.

10. A charged-particle beam pattern-writing method for writing a desired pattern by irradiating a surface of a sample with a charged-particle beam formed using a plurality of apertures, the method comprising:
using a first aperture including an opening of a quarter-circular shape on a first quadrant and a fourth quadrant and rectangular shape on a second quadrant and a third quadrant;
using a second aperture including an opening of a rectangular shape on a first quadrant and a fourth quadrant and quarter-circular shape on a second quadrant and a third quadrant; and
forming a charged-particle beam of a spindle-like cross-sectional shape by passing the beam through at least a portion of a region encompassing the first quadrant and fourth quadrant of the first aperture, and at least a portion of a region encompassing the second quadrant and third quadrant of the second aperture.
